(19) United States
(12) Patent Application Publication
(10) Pub. No.: US 2006/0075873 A1
(43) Pub. Date: Apr. 13, 2006

(54) Music box gearing

(75) Inventor: Gerhard Feldevert, Gronau (DE)

Correspondence Address: JORDAN AND HAMBURG LLP, 122 EAST 42ND STREET, SUITE 4000, NEW YORK, NY, 10168, US

(73) Assignee: KWO Kunstgewerbe-Werkstaetten GmbH, Olbernhau (DE)

(21) Appl. No.: 11/233,319

(22) Filed: Sep. 22, 2005

(30) Foreign Application Priority Data
Oct. 7, 2004 (DE) 20 2004 015 628.8

(51) Int. Cl. G10F 1/06

(52) U.S. Cl. 84/97

(57) ABSTRACT

A music box gearing with an integrated music box mechanism incorporates a main drive pinion for revolving units that also has a catch for securing the revolving unit. A music box casing incorporates a gear unit consisting at least of an adapter capable of attaching to the catch, a carrier rigidly connected with the adapter, at least one shaft mounted in the carrier, and a wheel rigidly connected with the shaft. A ring is immovably fixed in the casing in contact with the wheel, a revolving plate is rigidly connected with the adapter and carrier, and the plate incorporates a recess for the shaft, wherein the shaft executes a motion deviating from the parameters of the main drive pinion.

### BACKGROUND OF THE INVENTION

The invention is used in music boxes having a music box mechanism inside a casing and an additional main drive pinion for moving parts of the music box.

It has long been known for mechanical music box mechanisms predominantly driven by a spring energy store or an electric motor that the motion of parts in the music box casing can be facilitated by an additional main drive pinion. For example, the spring motor axis was lengthened in DE 577 296, the pin roller drive was lengthened in CH 352 221, and gear systems in which a contrite gear is used to deflect the axial position of the driving axis were realized. Also known are solutions in which the main drive pinion can be engaged or disengaged, and the rotational direction can be changed, e.g., as described in DD 251 422 A1.

It is here known that the energy supply is limited, preferably in autonomous music box mechanisms, as in those driven by spring stores, so that frictional losses must be largely avoided. Therefore, the main drive pinions described above were always limited to a single main drive pinion preferably designed as a shaft end with a threaded connection. Individual elements or figure panes that took up entire scenes could then be secured to the latter in such a way as not to cause any additional friction. The arranged elements or scenes were here static, and only cause the main drive pinion to rotate.

CH 352 221 proposes that a music box mechanism be equipped with a friction gear, wherein the frictional wheel runs over a respective cam plate, which has various curved segments, thereby enabling specific forms of movement. The friction gear is here to be designed as a flat disk, a roll or a structural unit comprised of various segmented disks. The rotational direction of the decorative objects here changes continuously.

The mentioned gearing forms a structural unit with the music box mechanism, and is offered by music box mechanism manufacturers in a model with three axes offset by a respective 120°. Music box manufacturers are then committed to the configuration of the prefabricated music box mechanisms, and hence limited in terms of potential music box designs. For example, the axial distance and distribution of friction gears, the rotational direction, speeds and directional change are rigidly prescribed, while a revolving plate cannot be additionally arranged on the music box casing.

Another disadvantage to the described solution is that the individual shafts are accommodated in a single sleeve fabricated from the respective retaining plate using the same material. As a result, no exact bearings can be obtained without reworking, and only short bore lengths can be achieved. The comparatively short axis guides then frequently lead to jamming and increase friction, wherein combinations with larger, fitted elements and irregular mass distribution can give rise to nonuniform running and end up blocking the music box mechanism.

Another important disadvantage to the music box mechanisms described above is that they are more difficult to repair. If the top of a music box casing is covered by a lid or revolving plate, decorative elements inserted on the axes cannot be secured. They must always be removed if repairs become necessary to provide access to the interior of the music boxy mechanism situated inside the music box casing. Also disadvantageous is that unfavorable tolerance conditions might arise, since the length between casing components and the music box mechanism can only be compensated via the axes.

### SUMMARY OF THE INVENTION

Therefore, an object of the invention is to provide a gearing solution that can be designed as a function of the size and shape of a music box casing and the number and rotational direction of additional main drive pinions, inexpensively manufactured and otherwise combined with nearly any conventional model of music box mechanism with an additional main drive pinion.

The invention is derived from the features in the claims for protection, the specification and the exemplary embodiments. The exemplary embodiments and drawings here illustrate embodiments preferred on the application date, and do not place any limitations on the invention.

The invention initially proceeds from the fact that a variable design of additional main drive pinions in music box mechanisms can be achieved by clearly separating the music box mechanism, gearing and casing or structure assemblies, while at the same time retaining the advantages to known solution, such as low friction.

Therefore, the gearing according to the invention is connected with the music box mechanism only via its main drive pinion, so that nearly any structural shape and size of a music box mechanism can be inserted given the right adapter design. In like manner, use can also be made of non-mechanical solutions for music box mechanisms with an electric motor or similarly acting drive.

The gearing unit is essentially designed with an upper carrier, a lower carrier and the gear wheels situated in between. Either the upper or lower or both carriers are linked with a centrally arranged adapter, which establishes the power coupling between the music box mechanism and gearing.

Preferably the upper carrier is rigidly secured to a revolving plate, which simultaneously forms the upper terminal of the music box casing. The upper and lower carriers are spaced apart from each other. The necessary distance can here be set using spacers, domes molded out of the same material, or comparable technical means. The bearings for the gear wheels are realized via boreholes introduced coaxially to each other.

The intermediate space between the mounts incorporates at least one gear wheel, which is guided by a shaft in the mentioned bearing boreholes. The shaft and wheel are rigidly connected, so that the shaft is axially fixed at the same time. One embodiment of the axis can be stepped, so that the axis can be guided in a bearing borehole with a small diameter situated below, while it has a larger diameter toward the top along with a greater length to accommodate decorative objects. It is also possible to provide the projecting sections of the axis with additional plates, so that several decorative objects can be arranged there.

The spaced apart bearing boreholes ensure that the shafts are precisely guided at a low level of friction and without jamming.

The gear wheels engage a stationary part, which is either latched to the floor of the music box casing by means of spacers, secured to the top of the music box mechanism, or fixed at a defined height in the music box casing.

The gear wheels contact the stationary part in a positive and/or non-positive manner.

Generally preferred are gearing wheels designed as frictional wheels with a conical, elliptical, or lenticular profile, since this makes misalignments during assembly meaningless, while simultaneously largely avoiding noise development. In like manner, short-term blockages cannot influence music box mechanism operation per se.

In one preferred embodiment, the upper and lower carriers are laid out like strips and joined in the middle, and an extension arm accommodates a gear wheel. In order to achieve weight balance, it may be advantageous to arrange a counterweight on the opposing side. This arrangement makes it possible to place laterally displaced, revolving decorative objects on a music box body, preferably on a revolving plate.

Another embodiment makes use of an opposing second gear wheel and two eccentrically arranged, revolving decorative objects, with the structural design otherwise being essentially the same. In like manner, three or more shafts can also be provided with the accompanying gear wheels.

It is possible to provide varyingly large axial distances relative to the central axis of the overall arrangement, wherein the distance to the stationary component is bridged by the respective varying diameter of the gear wheels.

The stationary component can be designed in such a way as to enable several ways for contacting gear wheels. In this way, identical, opposite or even alternating rotational directions with varying speeds can be achieved and combined. In the final analysis, the available options are limited by the assembly conditions and required dimensions of the components.

The connection to the main drive pinion of the music box mechanism or differently designed drive unit can consist either of a rigid connection, e.g., established by means of a threaded nipple, or solely through positive locking between a correspondingly shaped opening in the mounting sections of the gearing and a compatible catch.

In another embodiment of the invention, the stationary component is connected with the main drive pinion of the music box mechanism, while the gearing is secured to a rigidly secured cover of the music box casing. As a result, the top of the music box casing remains immobile, while at least one shaft extends out of the music box casing, can rotate based on the criteria described above, and can serve as a carrier for decorative objects or aids for accommodating the latter.

Therefore, the advantage to the invention is that it permits nearly any arrangement of additional, revolving decorative objects in the area of the at least also revolving plate or fixed upper terminal of the music box casing. The gearing arrangement is here connected with the revolving plate or the upper terminal of the music box casing, and can be detached in the component with the latter by disengaging the catch for the music box mechanism. Among other things, this also makes it possible to change the structural design at a low outlay, while retaining the same casing bottom and music box mechanism mounted therein.

The invention will be described in greater detail below based on two exemplary embodiments.

### BRIEF DESCRIPTION OF THE DRAWINGS

FIG. 1 is a diagrammatic view of a friction gear in an arrangement that includes a revolving plate and additionally revolving axes.

FIG. 2 is a diagrammatic view of a gearing in which a non-revolving plate and several revolving axes are driven via a friction gear.

### DESCRIPTION OF THE PREFERRED EMBODIMENTS

### Exemplary Embodiment 1

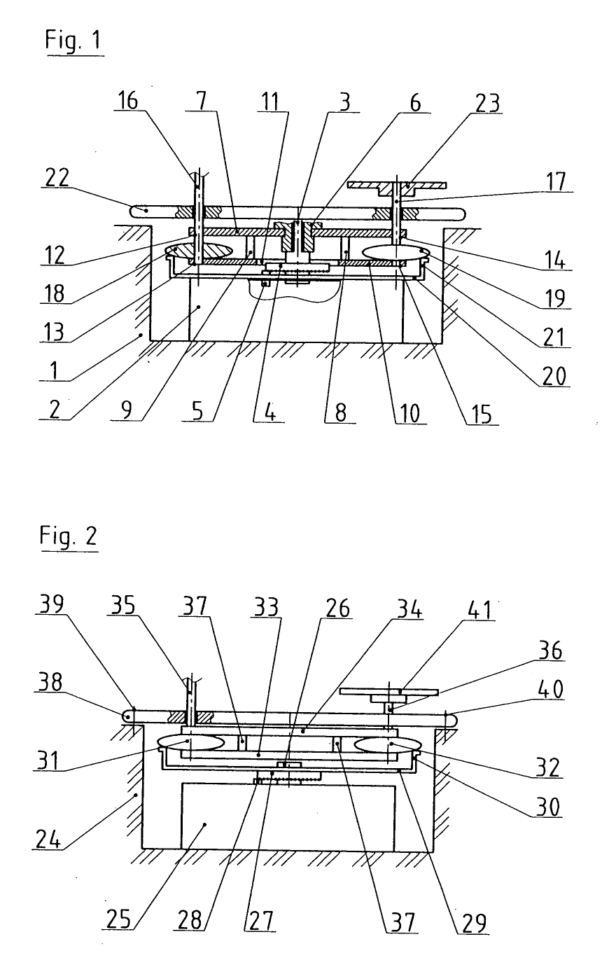

A music box casing (1) incorporates a music box mechanism (2) of whatever model desired. It has a main drive pinion (adapter), correspondingly shown on FIG. 1 as a conventional design with a shaft extension (3), contrite gear (4) and driving toothed wheel (5).

An upper carrier (7) is secured to the shaft extension (3) by means of the bushing (6), and holds the lower carrier (10) with spacers (8) and (9). The center of the lower carrier (10) preferably has a recess (11) that accommodates the contrite gear (4), so that the overall dimensions of the arrangement can be kept small.

The upper carrier (7) incorporates boreholes (12) and (13), and the lower carrier (10) incorporates boreholes (14) and (15), each coaxially flush to the other. These accommodate the shafts (16) and (17), wherein the position of the shafts (16) and (17) is ensured by the secure fit of the wheels (18) and (19). Another embodiment can involve providing the shafts (16) and (17) with a reduced diameter, and simultaneously giving the boreholes (12) and (13) as well as (14) and (15) a stepped bore diameter.

A ring (20) is rigidly connected with the music box mechanism (2), producing a motion relative to the stationary ring (20) when the shaft extension (3) is moved. The wheels (18) and (19) then roll on the edge (21) of the ring (20), imparting an additional motion to the shafts (16) and (17).

The revolving plate (22) hence moves at the same speed as the shaft extension (3), while the shafts (16) and (17) revolve at a speed that depends on the distance to the central axis of the shaft extension (3), the distance of its central axis to the edge (21). Therefore, an individual adjustment of the respective speeds can be achieved. Depending on the application requirements, the boreholes (12) and (13) as well as (14) and (15) can be arranged at varying distances from the central axis of the shaft extension (3).

The wheels (18) and (19) are preferably fabricated using a wear-proof material with a high friction coefficient, thereby ensuring reliable movement even when the gearing is designed as a friction gear.

The revolving plate (22) is preferably rigidly secured to the bushing (6), but can also be joined with the upper carrier (7) in another manner.

The shaft (..) carries a plate (23), for example, which can accommodate decorative objects that again move relative to those arranged on the revolving plate (22).

This gearing arrangement makes it possible to achieve broad latitude in configuring the decorative objects, in particular specific scenes, by varying the dimensional arrangement and number of shafts (16) and (17). Extensive adjustment of the movement sequences is also possible.

### Exemplary Embodiment 2

A music box casing (24) incorporates a music box mechanism (25), which in turn has a main drive pinion with a shaft extension (26), contrite gear (27) and driving toothed wheel (28).

A plate (29) is rigidly secured to the shaft extension (26), contrite gear (27) or both structural elements, and moves together with the mentioned components as they rotate. The edge (30) of the plate (29) contacts the wheels (31) and (32), which are designed as described in the preceding exemplary embodiment. The wheels (31) and (32) are in turn guided between a lower (33) and upper carrier (34), and fixed immovably on the shafts (35) and (36). The lower (33) and upper carriers (34) are further set to the required distance by means of spacers (37).

Situated over the gearing arrangement is an end cover plate (38), which is joined to the music box casing (24) at the connecting points (39) and (40), or in another manner. The shaft (36) carries an additional plate (41), which is suitable for accommodating decorative elements.

This gearing embodiment makes it possible to integrate additional moving objects into a stationary arrangement of decorative objects.

1. A music box gearing with an integrated music box mechanism, comprising a main drive pinion for revolving units, a catch for securing the revolving units, a music box casing incorporating a gear unit comprising at least an adapter capable of attaching to the catch, a carrier rigidly connected with the adapter, at least one shaft mounted in the carrier, a wheel rigidly connected with the shaft, a ring immovably fixed in the casing in contact with the wheel, a revolving plate rigidly connected with the adapter and carrier, and a plate incorporating a recess for the shaft, wherein the shaft executes a motion deviating from the parameters of the main drive pinion.

2. A music box gearing with an integrated music box mechanism, comprising a main drive pinion for revolving units, an adapter for securing the revolving units, a casing incorporating a gear unit comprising at least a carrier, at least one shaft mounted in the carrier, a wheel rigidly connected with the shaft, a ring connected with the adapter in contact with the wheel, a plate rigidly connected with the carrier and incorporating a recess for the shaft, wherein the shaft executes a motion deviating from the parameters of the main drive pinion.

3. The music box gearing according to claim 1, wherein the catch of the music box mechanism is a component connected with the gear unit adapter, preferably positive locking, preferably a threaded nipple.

4. The music box gearing according to claim 3, wherein the catch is connected with the carrier.

5. The music box gearing according to claim 3, wherein the catch is connected with the ring.

6. The music box gearing according to claim 1, wherein the carrier comprises an upper and lower component, the upper end lower components being spaced apart, and having bearing boreholes situated coaxilly to each other for accommodating the shafts.

7. The music box gearing according to claim 6, wherein the shaft is guided through the bearing boreholes present in the carrier, a wheel is secured to the shaft, and said wheel is arranged between the upper and lower component of the carrier.

8. The music box gearing according to claim 7, wherein the wheel contacts the ring in a positive manner.

9. The music box gearing according to claim 8, wherein the wheel is a frictional wheel having a cross section selected from the group which is elliptical, lenticular, conical or tapered.

10. The music box gearing according to claim 1, wherein more than one shaft is arranged in the carrier.

11. The music box gearing according to claim 10, wherein the distance between the shafts and central axis of the music box casing varies.

12. The music box gearing according to claim 11, wherein at least one shaft end carries an adapter and/or a plate.

13. The music box gearing according to claim 1, wherein the catch of the music box mechanism is a component connected with the gear unit adapter with positive locking.

14. The music box gearing according to claim 1, wherein the catch of the music box mechanism is a component connected with the gear unit adapter with a threaded nipple.

15. The music box gearing according to claim 8, wherein the wheel is a frictional wheel with its face running on an edge of the ring.

16. The music box gearing according to claim 8, wherein the wheel is a frictional wheel with its face running on a bead of the ring.

17. The music box gearing according to claim 10, wherein the wheels vary in diameter.

18. The music box gearing according to claim 10, wherein the wheels run on the ring with varying rolling radii.

19. The music box gearing according to claim 10, wherein the projecting shaft ends vary in length.
